(19) United States
(12) Patent Application Publication
(10) Pub. No.: US 2003/0053622 A1
(43) Pub. Date: Mar. 20, 2003

(54) Method for the construction of hash functions based on sylvester matrices, balanced incomplete block designs and error-correcting codes

(76) Inventors: Aiden Bruen, Calgary (CA); David Wehlau, Kingston (CA); Mario Forcinito, Calgary (CA)

Correspondence Address: Thomas P. Pavelko, Suite 850, 1615 L Street, N.W., Washington, DC, 20036, US

(21) Appl. No.: 10/245,510

(22) Filed: Sep. 18, 2002

(30) Foreign Application Priority Data
Sep. 20, 2001 (IE) S2001/0843

(51) Int. Cl. H04L 9/00

(52) U.S. Cl. 380/28

(57) ABSTRACT

An apparatus and method for constructing a hash function are provided such that an input string is mapped to an output string, the hash function being based on one of Sylvester matrices, balanced incomplete block designs, and error-correcting codes. The constructed hash function can be used by an apparatus for, among other uses, encrypting messages, determining if strings s and s′ are equal, and for respectively storing and retrieving data into and from a memory.

### RELATED APPLICATIONS

This application relates to our corresponding application Ser. No. ______ (Attorney Docket No. TPP31464) filed on the same date and entitled “A Key Agreement Protocol Based On Network Dynamics” naming Aiden BRUEN, David WEHLAU and Mario FORCINITO as the inventors.

### BACKGROUND OF THE INVENTION

1. Field of the Invention

The present invention relates to hash functions for mapping a set of input values S to a set of output T. More particularly, the present invention relates to hash functions for mapping a set of keys S to a set of target values T, which hash functions can be used to detect if two elements s, s′εS are in fact the same element and to respectively store and retrieve data into an from a memory.

2. Discussion of the Related Art

Hash functions are transformations that map from larger domains to smaller ranges. In many applications, such as digital signatures, it is necessary to have an irreversible function which takes an input string and returns a bit string of fixed length. Such one-way functions are referred to as one-way hash functions.

Hashing also may be viewed as a way to assign an abbreviation to a name. In this case the property of giving different results for different inputs is a desirable one. In practice, this property is required to be true “most of the time.” That is, there should be a very low probability of getting the same result whenever the inputs are different. Hash functions having this property are usually referred to as “collision free” [10].

Hash functions commonly used in encryption systems include message digest (MD5), secure hashing algorithm (SHA) and secure hashing standard (SHS) and are based on subjecting the input(s) to several rounds of certain modular arithmetic operations and taking appropriate sub-strings from the results. Other techniques involve the use of substitution boxes (S-boxes) or even the use of encryption algorithms, such as data encryption standard (DES) and advanced encryption standard (AES) since encryption algorithms can be considered as particular cases of hash functions.

Yet another and more general approach is to choose (randomly or not) one or more hash functions from a large set of such functions such that the resulting hash is some combination of the results of the application of these hash functions to the same input.

### SUMMARY OF THE INVENTION

The present invention provides a hash function H such that for two strings s and s′ the condition s≠s′ can be detected by applying this hash function H to each string and checking that H(s)≠H(s′). Conversely, by using the present invention, evidence for the equality of s and s′ can be obtained by verifying that H(s)=H(s′) for many different hash functions H.

Consider the case where S consists of a subset of the vector space of dimension n over the finite field having only two elements, 0 and 1. That is to say, assume that S is a set of strings s of binary bits, each string having length n.

Similarly, assume that T is a subset of the vector space of dimension m over the same finite field. That is to say, assume that T is a set of strings of binary bits, each string having length m.

Suppose further that it is desired to map S to T using a hash function H. The values of a hash function H may be written as a combination, such as a concatenation, of functions H(s)=(h₁(s), h₂(s), . . . , hₘ(s)) where each function h₁(s)ε{0,1}. The function H is completely determined by the projected functions h₁, h₂, . . . , hₘ. Therefore it suffices to consider hash functions which take their values in the finite field, {0, 1}. In summary, hash functions mapping a set of binary n-vectors to the set {0, 1} are constructed by the present invention.

The present invention provides a method and apparatus for constructing a hash function H that maps strings s of S to strings H(s) of T, wherein H(s)=(hi(s), h₂(s), . . . , hₘ(s)) such that each hᵢ(s) ε{0, 1}, all hᵢ(s) being based on one of Sylvester matrices, balanced incomplete block designs, and error-correcting codes.

### BRIEF DESCRIPTION OF THE DRAWINGS

FIG. 1 illustrates construction of a hash function according to an embodiment of the present invention employing block designs.

FIG. 2 illustrates construction of a hash function according to an embodiment of the present invention employing algebraic codes.

FIG. 3 illustrates construction of a hash function according to the present invention for an input key corresponding to data to be stored/retrieved in/from a memory by a computer apparatus.

FIG. 4 illustrates a computer apparatus at cryptographic station A and B that employs a hash function constructed according to the present invention to obtain an unconditionally secure cryptographic key from the keys received at each station.

FIG. 5 illustrates determining equality of tow input strings by a computer apparatus at station A and B using a hash function H constructed according to the present invention.

FIG. 6 illustrates a computer apparatus obtaining a cryptographic digital signature from an algorithm that uses a hash function, the has function being constructed according to the present invention.

FIG. 7 illustrates a computer apparatus constructing a hash function according to the present invention for a given input string and then using this hash function to perform cryptographic message authentication.

### DETAILED DESCRIPTION OF THE INVENTION

The present invention provides a method for obtaining a hash function H=(h₁(s), h₂(s), . . . , hₘ(s)) over a given finite field using Sylvester matrices, block designs or algebraic codes.

Hash Functions Using Block Designs

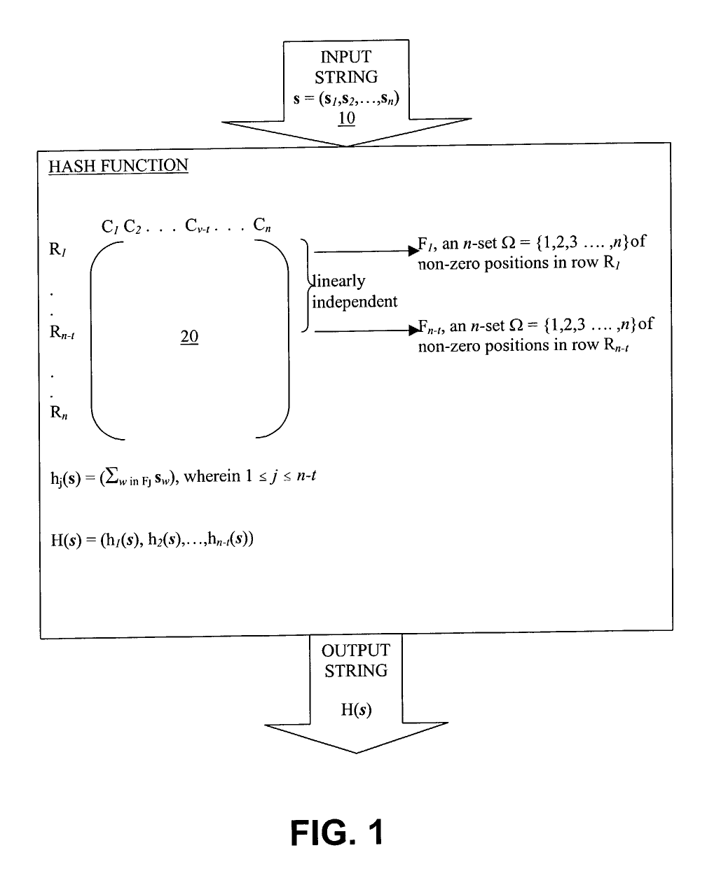

Referring now to FIG. 1, a suitable hash function H(s)=(h₁(s), h₂(s), . . . , hₙ₋ₜ(s)) can be obtained in the following way. Let s={S₁, S₂, . . . , sₙ} 10 be a binary vector of length n. In one preferred embodiment, a set of n−t functions {h₁(s), h₂(s), . . . , hₙ₋ₜ(s)}, where t>0, is obtained as follows.

(1) Choose a family F of n−t linearly independent (with respect to symmetric difference) subsets of an n-set Ω={1, 2, 3 . . . , n}.

(2) Write F={F₁, F₂, . . . , Fₙ₋ₜ}, e.g., as the first n−t rows of an n×n matrix 20.

(3) Then define h₁, h₂, . . . , hₙ₋ₜ by hⱼ(s)=(Σ_{w in Fj} s_{w})(mod 2), wherein 1≦j≦n−t. These functions are described in [1] and [2]. Of course any such family F may suffice.

(4) Set H(s)=(h₁(s), h₂(s), . . . , hₙ₋ₜ(s)).

However, in a preferred embodiment, when H is employed to encrypt S in order to maximize the difficulty of eavesdropping, F is constructed so that it has regularity properties. That is, it is required that the subset in F be “well spread out.” Ideally the family F has the property that any two elements in Ω lie in a constant number of subsets in F. Further, it is desirable also that each subset in F has the same cardinality and that two different subsets in F intersect in a constant number of elements. Indeed these are the criteria that motivated the design of experiments in statistics [3], [4] leading to the combinatorial study of block-designs (see [5] and [6]) In cryptography a condition known as the Avalanche Criterion (AC) is used in the analysis of S-boxes or substitution boxes (see for example [7], [8]), in which each S-box takes a 6-bit input and produces a 4-bit output such that bits of a ciphertext depend on bits of a plaintext and bits of a key used to encrypt the plaintext to produce the ciphertext. The present invention adapts this criterion to hash functions such that, given a set of hash functions with values in {0, 1}, if one bit of the input string is changed then the Avalanche Criterion requires that about half of the hash functions should change their output values.

In a preferred embodiment of the present invention, block designs are employed to construct a family of hash functions that satisfies all of these desirable criteria. A particular kind of block design arises from Sylvester matrices, the so-called Hadamard designs. Let H denote a 4t×4t Hadamard matrix. This means that every entry in H is a 1 or −1 and that HH^{t}=4t I₄ₜt. Assume that such a matrix exists. There is a long standing open conjecture that at least one 4t×4t Hadamard matrix exists for every t. This conjecture has been verified for all t≦117. Furthermore, for infinitely many larger values of t, it is known that a 4t×4t Hadamard matrices does exist.

Suppose that H has been normalized so that its first row and first column consist entirely of 1's. A new a 4t−1×4t−1 matrix \overline{H} is constructed, all of whose entries are either 0 or 1, as follows. The first row and first column (consisting of all 1's) are deleted from H and then every −1 in the remaining matrix is changed to 0. The resulting matrix is H. This matrix is the incidence matrix 20 of a block design with v=4t, k=2t−1 and λ=t−1. This design is called a Hadamard 2-design.

For each row, r, of \overline{H} define a linear hash function hᵣ which maps a 4t−1-vector into its dot product with the row r. These 4t−1 different hash functions satisfy the Avalanche Criterion as well as the other desirable conditions listed above.

If t is odd then these 4t−1 linear hash functions are linearly independent. This fails if t is even. However, in this case, a large subset to the 4t−1 hash functions are linearly independent.

Suppose that n ≠3 (mod 4). Then a Hadamard design of size n cannot be constructed. In this case, a preferred embodiment of the present invention requires the use of the least integer n′>n where n′≡3 (mod 4) and the extension of input strings to length n′ by padding on the right with (at most 3) zeroes. This results in n′ hash functions which are linearly dependent.

Hash Functions Using Algebraic Codes

Traditionally in cryptography binary codes are used as follows (see [9]). A string x is embedded in a code-word \tilde{x} belonging to some code C where \tilde{x} is obtained from x by adjoining to x parity bits corresponding to C. Traditional approaches, on the assumption of few errors, attempt to decode \tilde{x} from x. Here a new approach is provided by the present invention.

Recall that the hash function H is constructed to help decide whether two elements s and s′ of S are equal. Consider the special situation where it is known (or known with high probability) that the Hamming distance between s and s′ is less than some small integer d. In other words it is known that the number of bits where s and s′ differ is less than d.

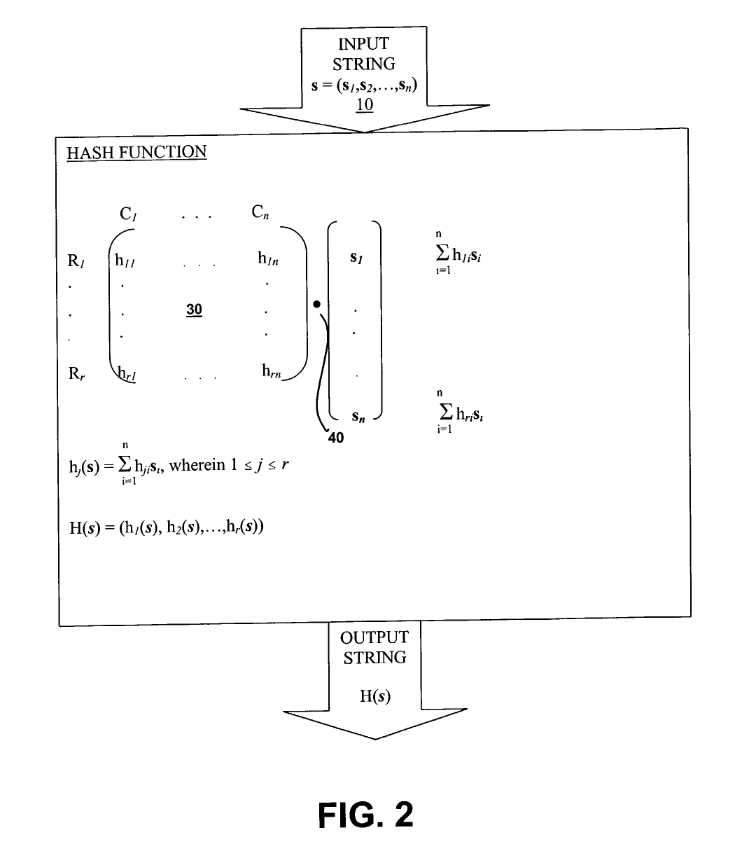

Referring now to FIG. 2, consider an r×n matrix K 30 which is the parity check matrix of a code of minimum distance at least d. This means that the subspace of vectors perpendicular to every row of K 30 contains only one vector of Hamming weight less than or equal to d, namely, the zero vector. For each row r of K 30 define a function hᵣ by taking hᵣ(s) to be the dot product of row r and vector s. Thus, given vectors s and s′ such that hᵣ(s)=hᵣ(s′) for all rows r of K 30 then s+s′ is an element of the code of minimum distance d. Therefore either s=s′ or else the Hamming distance between s and s′ is at least d (s differs from s′ by at least d bits) and the desired hash function is H(s)=h₁(s), . . . , hᵣ(s).

### EXAMPLE

Suppose that n is some integer with 64<n≦128 and that A and B are two binary vectors of length n. An 8×128 parity check matrix K 30 is constructed. First, a 7×128 matrix \overline{K} is constructed. Consider the 128 columns of \overline{K}. All 128 columns of \overline{K} should be distinct (different). Take the first 8 columns of \overline{K} to be:

$$( \begin{matrix}0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & 1 & 0 \\ 0 & 0 & 0 & 0 & 0 & 0 & 0 & 1\end{matrix} )$$

The remaining 120 distinct columns of \overline{K} may be arranged in any order, say in lexicographic order.

Next, K 30 is obtained from \overline{K} by adding a row consisting entirely of 1's to the top of K. Then K 30 is the parity check matrix for a code of minimum distance 4. There are 8 hash functions h₁, h₂, . . . , h₈ obtained by defining hᵢ to be the dot product 40 with row i of K 30. Now if n<128, A and B are extended to new binary strings A′ and B′ of length 128 by adding 0's to the right of A and B. (Equivalently, the last 128−n columns may be truncated from K 30.) Now if hᵢ(A′)=hᵢ(B′) for all i=1, 2, . . . , 8 then either A′=B′ or else the Hamming distance from A′ to B′ is at least 4. Thus, clearly, either A=B or the Hamming distance from A to B is at least 4. The desired has function is

H(A)=h₁(A), . . . , h₈(A).

Security

Finally, consider the extra possibility that it is desired to conceal the values of A and B from some eavesdropper, Eve, who has learned the values h₁(A), h₁(B), . . . , h₈(A), h₈(B). In this case the first 8 bits may be deleted from A and B leaving binary strings \overline{A} and \overline{B} of length n−8. Although 8 bits have been lost from A and B this is compensated for by the fact that Eve's knowledge of the values hᵢ(A) and hᵢ(B) provides her with no information about \overline{A} and \overline{B}.

Apparatus

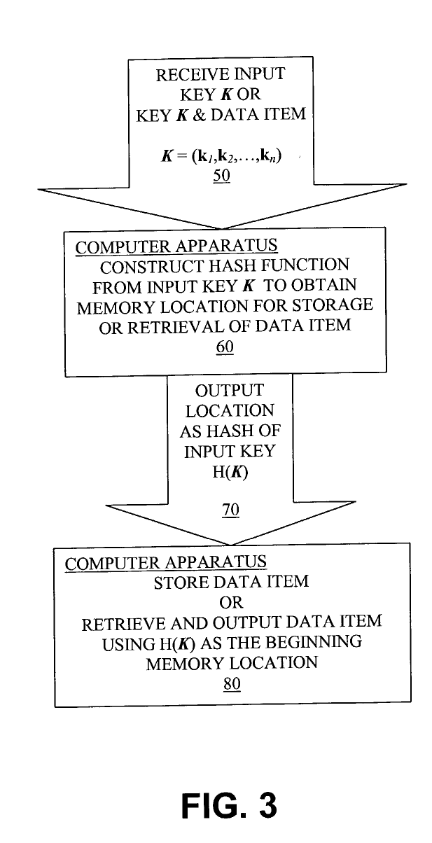

In a preferred embodiment, as illustrated in FIG. 3, a computer apparatus 60, preferably comprising at least one processor and at least one memory, is able to employ a hash function H(K) 70 constructed according to the present invention in order to obtain a memory location corresponding to a received input key K associated with a data item 50 and then the same or another computer apparatus 80, preferably comprising at least one processor and at least one memory, is able to retrieve and store, beginning at location H(K), the received data item associated with the received input key K.

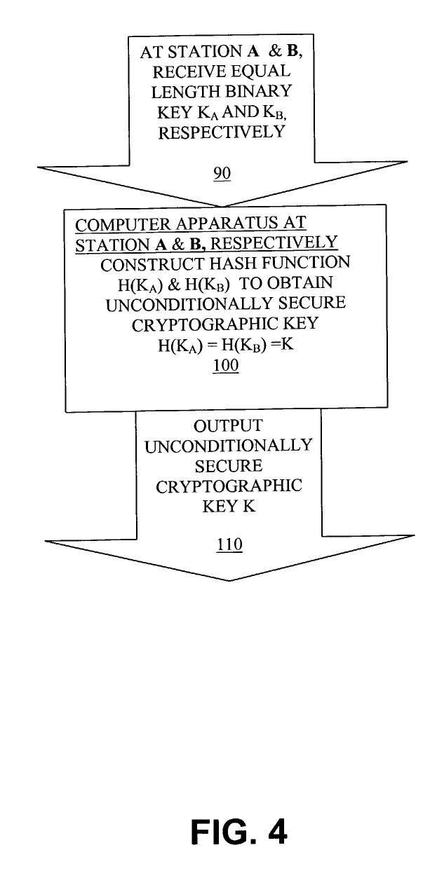

In FIGS. 4-7 the computer apparatus similarly comprises at least one memory and/or at least one processor.

Similarly, FIG. 4 illustrates a computer apparatus 100 at cryptographic stations A and B that is able to employ the hash function constructed according to the present invention 100, to obtain and output 110 of an unconditionally secure cryptographic key from the respective received key K_{A}, K_{B} wherein K_{A}=K_{B} 90.

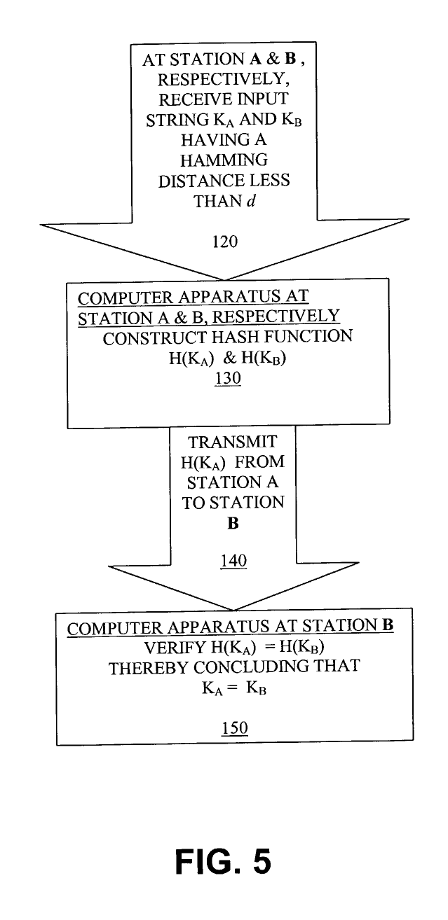

And, as shown in FIG. 5, determination of the equality of two input strings K_{A} and K_{B} 120 can be accomplished by a computer apparatus 130 employed by station A and B that is able to construct a hash function H and obtain H(K_{A}) and H(K_{B}), with station A transmitting H(K_{A}) to station B 140 such that station B is able to verify that H(K_{A})=H(K_{B}) and thereby conclude that K_{A}=K_{B} 150.

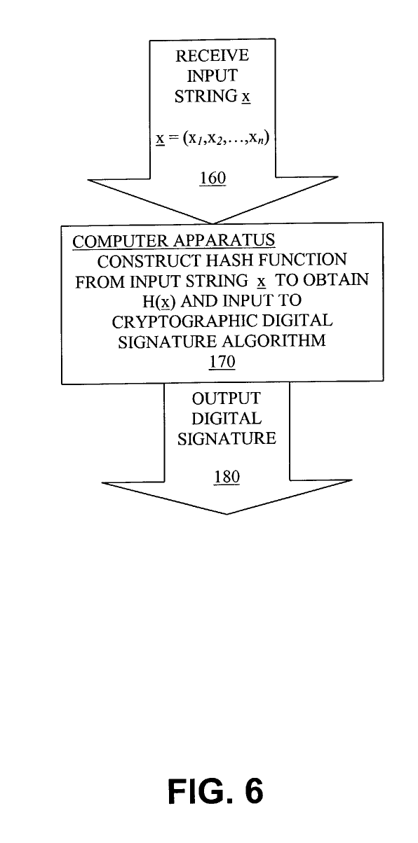

FIG. 6 illustrates a computer apparatus 170 that is able to obtain a cryptographic digital signature for a received input string 160 and then output the obtained cryptographic digital signature 180.

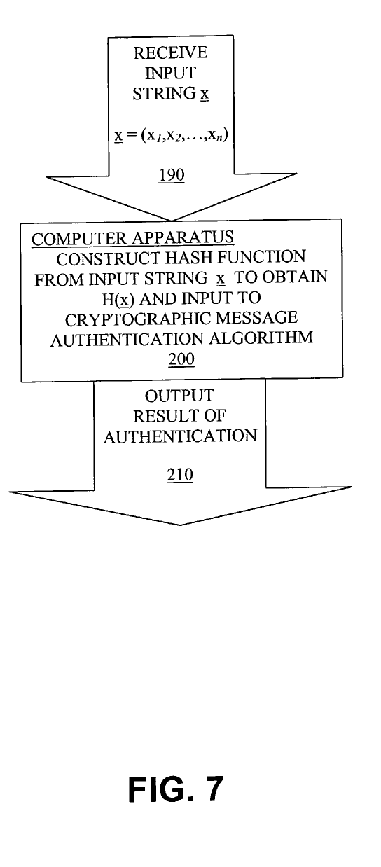

FIG. 7 illustrates a computer apparatus 200 that is able to receive an input string 190 and from this received string is then able to construct a hash function according to the present invention and perform cryptographic message authentication using this hash function, finally outputting the result of the authentication 210.

It will be understand by those skilled in the art that the above-described embodiments are but examples from which it is possible to deviate without departing from the scope of the invention as defined by the appended claims.

### REFERENCES AND BIBLIOGRAPHY

The following references as well as any reference mentioned elsewhere in this specification are hereby incorporated by reference as in fully set forth herein.

[1] Charles Bennett, François Bessette, Gilles Brassard, Louis Salvail, and John Smolin, Experimental quantum cryptography, EUROPCRYPT '90 (Arhus, Denmark), 1990, pp. 253-265.

[2] Samuel J. Lomonaco, A quick glance at quantum cryptography, Cryptologia 23 (1999), no. 1, 1-41.

[3] R. A. Fisher and F. Yates. Statistical Tables for Biological, Agricultural and Medical Research. Oliver-and-Boyd Ltd., third edition, 1948.

[4] D. Rhaghabarao. Constructions and Combinatorial Problems in the Design of Experiments. John Wiley & Sons, 1971.

[5] H. Lenz Thomas Beth, D. Jungnickel. Design Theory. Cambridge University Press, 1986.

[6] P. J. Cameron and G. E. van Lint. Designs, Graphs, Codes and their Lenghts. Cambridge University Press, 1991. London Math Soc. Student Text vol 22.

[7] Richard A. Mollin. An Introduction to Cryptography. Chapman & Hall/CRC Press, 2000.

[8] R K Nichols, editor. ICSA Guide to Cryptography. Mc Craw Hill, 1999.

[9] Charles H. Bennett, Gilles Brassard, and Jean-Marc Robert, Privacy Amplification by Public Discussion, Siam J. of Computing, 17, no.2 (1988), 210-229.

We claim:

1. A method of constructing a hash function H(x), for mapping an input string x=(x₁, x₂, . . . , xₙ) of length n>0 to an output string of length n−t, 1<t<n, of the set of strings H(x)={(h₁(x), h₂(x), . . . , hₙ₋ₜ(x))}, said input and output string being defined over a given finite field F and H(x) being defined as a concatenation of said functions hᵢ(x), said method comprising the steps of:
a) providing a binary incidence matrix A having n columns and n rows, for a balanced incomplete block design on n points;
b) selecting a set of n-t rows, R₁, R₂, . . . , Rₙ₋ₜ, of the rows of A such that said selected n−t rows are linearly independent over F, wherein no F-linear independent combination of said selected set of n−t rows is a zero row save for an all-zero linear combination of said selected set of rows;
c) for each said row Rᵢ, obtaining a subset Fᵢ, of a n-set Ω={1, 2, . . . n}, said subset being positions in which the row Rᵢ has a 1, wherein 1≦i≦n−t.
d) for said input string, setting_hᵢ(x)=(Σ_{w in Fi x}_{w}), wherein 1≦i≦n−t; and
e) defining said hash function as an output string created by the concatenation of hᵢ(x) for 1≦i≦n−t, H(x)=(h₁(x), h₂(x), . . . , hₙ₋ₜ(x))

2. The method of claim 1, further comprising the steps of:
a.1) providing the input string xas a concatenation of 1^{st} through component strings y₁, y₂, . . . yₛ of length v₁, v₂, . . . vₛ; and
a.2) conducting steps a) through e) on each of said 1^{st} through s^{th} component string y₁, Y₂, . . . yₛ, such that H(x) is a concatenation of the hash functions defined by step e) for each of said 1^{st} through s^{th} component strings, namely, H₁(y₁), H₂(y₂), . . . , Hₛ(yₛ).

3. The method of claim 1, wherein F=Z₂, the binary field consisting of the elements 0, 1.

4. The method of claim 1, wherein F=Z2 and A is an incidence matrix of Hadamard design on n points with n □3(mod 4), obtained from a Sylvester matrix of size (n+1)×(n+1).

5. A method of constructing a hash function H(x) for mapping an input string x=(x₁, x₂, . . . , xᵥ) of length n>0 to an output string H(x)={(h₁(x), h₂(x), . . . , hₙ₋ₜ(x))} of length n−t, 1<t<n, said method comprising the steps of:
a) providing a matrix M having size (n−t)×n, rows Rᵢ x columns, and rank n−t over a given finite field F whereby the Hamming distance between any two distinct vectors obtained from a distinct linear combination of the rows of M, is at least d, where d is some pre-assigned positive integer;
b) for each said row Rᵢ of M, setting hᵢ(x)=x·R₁, 1≦i≦n−t where denotes the dot product operation; and
c) defining said hash function H(x) as the function H(x)={(h₁(x), h₂(x), . . . , hₙ₋ₜ(x))}for l<t□n.

6. The method of claim 5, wherein F=Z₂, the binary field consisting of the elements 0,1.

7. The method of claim 5, wherein M is a generator matrix for a linear code having a minimum distance d over the field F.

8. The method of claim 5, further comprising the steps of
a.1) providing the input string (x) as a concatenation of 1^{st} through s^{th} component string y₁, y₂, . . . yₛ_of length v₁, v₂, . . . vₛ; and
a.2) conducting steps a) through c) on each of said 1^{st} through s^{th} component strings y₁, y₂, . . . yₛ, such that H(x) is a concatenation of the hash functions defined by step c) for each of said 1^{st} through s^{th} component strings, namely, H₁(y₁), H₂(y₂) . . . Hₛ(yₛ).

9. A method of verifying with certainty that a first and second cryptographic string K_{A} and K_{B} over a finite field F in first and second cryptographic station A and B, respectively, are equal, wherein the Hamming distance between said first and second string K_{A} and K_{B} is less than a pre-assigned positive integer d, said method comprising the steps of:
a) choosing a linear code C over F, said linear code C having a minimum distance d;
b) publicly selecting a generator matrix M for said linear code C, said matrix M having a size (n−t)×n, rows x columns;
c) in said first cryptographic station A, transmitting H(K_{A}) to said second station B, wherein H is constructed by the method of claim 1, wherein M is provided as the incidence matrix of step a);
d) in said second cryptographic station B, verifying that H(K_{A})=H(K_{B}), wherein H(K_{B}) is constructed by the method of claim 1, wherein M is provided as the incidence matrix of step a); and
e) when H(K_{A})=H(K_{B}), concluding with certainty that K_{A}=K_{B}.

10. A method of generating an unconditionally secure cryptographic key between a first and second cryptographic station A and B given a binary key K_{A} in said first station A and a binary key K_{B} in said second station B having a common length n and such that K_{A}=K_{B}=K, wherein at most t Shannon bits of the key K are known to an eavesdropper Eve, said method comprising the steps of:
a) in said first and second station A and B for said given binary key K=K_{A}=K_{B}, constructing a hash function H by the method of claim 1; and
b) in said first station and second station A and B, respectively, calculating an unconditionally secure cryptographic key L=H(K_{A}) and L=H(K_{B}).

11. A method of performing a cryptographic digital signature algorithm that utilises a hash function, wherein said hash function is constructed according to the method of claim 1.

12. A method of performing a cryptographic digital signature algorithm that utilises a hash function, wherein said hash function is constructed according to the method of claim 5.

13. A method of performing a cryptographic message authentication algorithm (MAC) that utilises a hash function, wherein said hash function is constructed according to the method of claim 1.

14. A method of performing a cryptographic message authentication algorithm (MAC) that utilises a hash function, wherein said hash function is constructed according to the method of claim 5.

15. A memory look-up method for retrieving and storing a data item in a location of a memory which is associated with at least one particular value of an input string x=(x₁, x₂, . . . , xₙ) of length n>0, said method comprising the steps of:
a) receiving said input string x;
b) constructing a hash function H according to the method of claim 1 to map said received input string x to an output string H(x), wherein said output string H(x) indicates a location in said memory at which said data item can be retrieved and stored; and
c) employing said output string H(x) to respectively retrieve and store said data item from and into said location of said memory.

16. A memory look-up method for retrieving and storing a data item in a location of a memory which is associated with at least one particular value of an input string x=(x₁, x₂, . . . . , xₙ) of length n>0, said method comprising the steps of:
a) receiving said input string x;
b) constructing a hash function H according to the method of claim 5 to map said received input string x to an output string H(x), wherein said output string H(x) indicates a location in said memory at which said data item can be retrieved and stored; and
c) employing said output string H(x) to respectively retrieve and store said data item from and into said memory.

17. A computer apparatus comprising a computer and a memory able to perform the algorithm of claim 1 to construct a beginning memory location as the output value H(K) from an input string x equal to a key K for at least one of storing data associated with said key K starting at said beginning memory location H(K) and retrieving data from said beginning memory location H(K).

18. A computer apparatus comprising a memory and a processor able to perform the algorithm of claim 5 to construct a beginning memory location as the output value H(K) from an input string x equal to a key K for at least one of storing data associated with said key K starting at said beginning memory location H(K) and retrieving data from said beginning memory location H(K).

19. A first and second computer apparatus comprising a processor at a first and second cryptographic station A and B, wherein each of said first and second computer apparatus is able to perform the algorithm of claim 10 to generate an unconditionally secure cryptographic key from a received input string K, said input string K having at most t Shannon bits of K known to an eavesdropper Eve.

20. A computer apparatus comprising a processor able to perform the algorithm of claim 1 for each of a first and second input string, K_{A} and K_{B}, in order to obtain first and second hash functions H(K_{A}) and H(K_{B}) and determine that K_{A}=K_{B} whenever H(K_{A})=H(K_{B}).

21. A computer apparatus comprising a processor able to perform the algorithm of claim 5 for each of a first and second input string, K_{A} and K_{B}, in order to obtain first and second hash functions H(K_{A}) and H(K_{B}) and determine that K_{A}=K_{B} whenever H(K_{A})=H(K_{B}).

22. A computer apparatus comprising a processor able to perform the algorithm of claim 1 for constructing a hash function as input to performing a cryptographic digital signature algorithm that utilizes said hash function.

23. A computer apparatus comprising a processor able to perform the algorithm of claim 5 for constructing a hash function as input to performing a cryptographic digital signature algorithm that utilizes said hash function.

24. A computer apparatus comprising a processor able to perform the algorithm of claim 1 for constructing a hash function as input to performing a cryptographic message authentication algorithm (MAC) that utilizes said hash function.

25. A computer apparatus comprising a processor able to perform the algorithm of claim 5 for constructing a hash function as input to performing a cryptographic message authentication algorithm (MAC) that utilizes said hash function.
